(19) United States
(12) Patent Application Publication
(10) Pub. No.: US 2025/0253927 A1
(43) Pub. Date: Aug. 7, 2025

(54) SENSING-AIDED RADIO ACCESS TECHNOLOGY COMMUNICATIONS

(71) Applicant: QUALCOMM Incorporated, San Diego, CA (US)

(72) Inventors: Hui GUO, Beijing (CN); Kyle Chi GUAN, NEW YORK, NY (US); Lan YU, Beijing (CN); Kapil GULATI, Belle Mead, NJ (US); Gene Wesley MARSH, San Diego, CA (US); Peng CHENG, Beijing (CN)

(21) Appl. No.: 18/854,915

(22) PCT Filed: May 12, 2022
(86) PCT No.: PCT/CN2022/092384

§ 371 Date: Oct. 7, 2024

(51) Int. Cl. H04B 7/08; H04B 7/06; H04W 64/00

(52) U.S. Cl. CPC H04B 7/088; H04B 7/06952; H04W 64/00

(57) ABSTRACT

Methods, systems, and devices for wireless communications are described. Generally, the described techniques provide for using situational information provided by a first user equipment (UE) to a first network entity to aid in communications between a second UE and a second network entity. The first network entity may receive the situational information from the first UE and may generate assistance information associated with the second UE based on the situational information. The situational information may be sensing data collected at the first UE and may, in some examples, include a position, velocity, acceleration, or the like, associated with the second UE and other UEs surrounding the second UE. The first network entity may then provide the assistance information to the second network entity, the second UE, or both, and these devices may use the assistance information to identify suitable configurations for communicating with each other.

### CROSS REFERENCE

The present application is a 371 national stage filing of International PCT Application No. PCT/CN2022/092384 by GUO et al. entitled “SENSING-AIDED RADIO ACCESS TECHNOLOGY COMMUNICATIONS,” filed May 12, 2022, which is assigned to the assignee hereof, and which is expressly incorporated by reference in its entirety herein.

### FIELD OF TECHNOLOGY

The following relates to wireless communications, including sensing-aided radio access technology (RAT) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support communications between a UE and a network entity using one or more radio access technologies (RATs). In such systems, it may be appropriate for the UE and the network entity to identify suitable configurations for communicating using the one or more RATs. Improved techniques for identifying configurations for communicating using one or more RATs may be desirable.

### SUMMARY

The described techniques relate to improved methods, systems, devices, and apparatuses that support sensing-aided radio access technology (RAT) communications. Generally, the described techniques provide for situational information transmitted by a first UE to a first network entity to aid in communications between a second UE and a second network entity. The first network entity may receive the situational information from the first UE and may generate assistance information associated with the second UE based on the situational information. The situational information may be sensing data collected at the first UE and may, in some examples, include a position, velocity, acceleration, or the like, associated with the second UE and other UEs surrounding the second UE. The first network entity may then provide the assistance information to the second network entity, the second UE, or both, and these devices may use the assistance information to identify suitable configurations for communicating with each other.

A method for wireless communication at a first network entity is described. The method may include receiving situational information from a first UE, generating assistance information associated with a second UE different from the first UE, the assistance information being based on the situational information and including one or more parameters indicative of a condition of the second UE, the second UE being linked to the first UE, and transmitting at least a portion of the assistance information to a second network entity different from the first network entity.

An apparatus for wireless communication at a first network entity is described. The apparatus may include a processor, memory coupled with the processor, and instructions stored in the memory. The instructions may be executable by the processor to cause the apparatus to receive situational information from a first UE, generate assistance information associated with a second UE different from the first UE, the assistance information being based on the situational information and including one or more parameters indicative of a condition of the second UE, the second UE being linked to the first UE, and transmit at least a portion of the assistance information to a second network entity different from the first network entity.

Another apparatus for wireless communication at a first network entity is described. The apparatus may include means for receiving situational information from a first UE, means for generating assistance information associated with a second UE different from the first UE, the assistance information being based on the situational information and including one or more parameters indicative of a condition of the second UE, the second UE being linked to the first UE, and means for transmitting at least a portion of the assistance information to a second network entity different from the first network entity.

A non-transitory computer-readable medium storing code for wireless communication at a first network entity is described. The code may include instructions executable by a processor to receive situational information from a first UE, generate assistance information associated with a second UE different from the first UE, the assistance information being based on the situational information and including one or more parameters indicative of a condition of the second UE, the second UE being linked to the first UE, and transmit at least a portion of the assistance information to a second network entity different from the first network entity.

Some examples of the method, apparatuses, and non-transitory computer-readable medium described herein may further include operations, features, means, or instructions for determining a first position of the second UE based on the situational information and determining a second position of the second network entity, where transmitting the assistance information to the second network entity may be based on a distance between the first position and the second position satisfying a distance threshold.

In some examples of the method, apparatuses, and non-transitory computer-readable medium described herein, generating the assistance information may include operations, features, means, or instructions for identifying one or more recommended or restricted beam directions for beam selection at the second network entity based on the situational information, and where transmitting at least the portion of the assistance information to the second network entity includes and transmitting the one or more recommended or restricted beam directions for beam selection to the second network entity.

Some examples of the method, apparatuses, and non-transitory computer-readable medium described herein may further include operations, features, means, or instructions for transmitting at least another portion of the assistance information to the second UE to aid in communications between the second UE and the second network entity.

In some examples of the method, apparatuses, and non-transitory computer-readable medium described herein, the other portion of the assistance information includes one or more recommended or restricted beam directions for beam selection at the second UE, a range of a beam sweep for the second UE to perform during beam selection, or a combination thereof.

In some examples of the method, apparatuses, and non-transitory computer-readable medium described herein, the other portion of the assistance information includes handover information associated with a third network entity, measurements associated with the third network entity, an indication of interference from nearby network entities, measurement demands from nearby network entities, or a combination thereof.

Some examples of the method, apparatuses, and non-transitory computer-readable medium described herein may further include operations, features, means, or instructions for determining that the second network entity may be associated with a serving cell for communicating with the second UE, where transmitting the assistance information to the second network entity may be based on the determining.

Some examples of the method, apparatuses, and non-transitory computer-readable medium described herein may further include operations, features, means, or instructions for selecting one or more network entities including the second network entity for coordinated multipoint communications with the second UE and coordinating communications between the second UE and the selected one or more network entities based on the assistance information.

Some examples of the method, apparatuses, and non-transitory computer-readable medium described herein may further include operations, features, means, or instructions for predicting a future position of the second UE based on the situational information, where transmitting the assistance information to the second network entity includes and transmitting a message indicating the predicted future position to the second network entity.

In some examples of the method, apparatuses, and non-transitory computer-readable medium described herein, the situational information includes a position of the second UE, a propagation loss associated with communications with the second UE, a velocity of the second UE, a movement direction of the second UE, a speed of the second UE, an acceleration of the second UE, a location or other motional information of one or more objects surrounding the second UE, or a combination thereof.

In some examples of the method, apparatuses, and non-transitory computer-readable medium described herein, the situational information may be based on data collected at one or more sensors at the first UE, one or more sensors at one or more other UEs, or a combination thereof.

In some examples of the method, apparatuses, and non-transitory computer-readable medium described herein, the first network entity and the second network entity may be associated with different radio access technologies or a same RAT.

A method for wireless communication at a first network entity is described. The method may include receiving, from a second network entity, assistance information associated with a first UE, where the assistance information is based on situational information from a second UE different from the first UE, determining one or more configurations for communicating with the first UE based on the assistance information received from the second network entity, and communicating with the first UE using the one or more configurations.

An apparatus for wireless communication at a first network entity is described. The apparatus may include a processor, memory coupled with the processor, and instructions stored in the memory. The instructions may be executable by the processor to cause the apparatus to receive, from a second network entity, assistance information associated with a first UE, where the assistance information is based on situational information from a second UE different from the first UE, determine one or more configurations for communicating with the first UE based on the assistance information received from the second network entity, and communicate with the first UE using the one or more configurations.

Another apparatus for wireless communication at a first network entity is described. The apparatus may include means for receiving, from a second network entity, assistance information associated with a first UE, where the assistance information is based on situational information from a second UE different from the first UE, means for determining one or more configurations for communicating with the first UE based on the assistance information received from the second network entity, and means for communicating with the first UE using the one or more configurations.

A non-transitory computer-readable medium storing code for wireless communication at a first network entity is described. The code may include instructions executable by a processor to receive, from a second network entity, assistance information associated with a first UE, where the assistance information is based on situational information from a second UE different from the first UE, determine one or more configurations for communicating with the first UE based on the assistance information received from the second network entity, and communicate with the first UE using the one or more configurations.

In some examples of the method, apparatuses, and non-transitory computer-readable medium described herein, determining the one or more configurations for communicating with the first UE may include operations, features, means, or instructions for determining, based on the assistance information, a set of directional beams associated with a beam sweeping operation for selecting a beam for communicating with the first UE, the method further including and performing the beam sweeping operation using the set of directional beams, where the communicating with the first UE may be based on the beam sweeping operation.

In some examples of the method, apparatuses, and non-transitory computer-readable medium described herein, determining the one or more configurations for communicating with the first UE may include operations, features, means, or instructions for determining, based on the assistance information, at least one of resources or a modulation and coding scheme for communicating with the first UE, where the communicating with the first UE may be based on the resources, the modulation and coding scheme, or both.

In some examples of the method, apparatuses, and non-transitory computer-readable medium described herein, determining the one or more configurations for communicating with the first UE may include operations, features, means, or instructions for determining, based on the assistance information, one or more power allocation configurations, one or more interference mitigation configurations, or both, for communicating with the first UE, where the communicating with the first UE may be based on the one or more power allocation configurations, the one or more interference mitigation configurations, or both.

Some examples of the method, apparatuses, and non-transitory computer-readable medium described herein may further include operations, features, means, or instructions for transmitting, based on the assistance information, control information configuring one or more of a set of directional beams associated with a beam sweeping operation, reference signal transmissions, or a threshold number of retransmissions for communicating with the first UE, where the communicating with the first UE may be based on the control information.

In some examples of the method, apparatuses, and non-transitory computer-readable medium described herein, the situational information includes a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

A method for wireless communication at a first UE is described. The method may include receiving assistance information associated with the first UE, where the assistance information is based on situational information from a second UE different from the first UE, determining one or more configurations for communicating with a network entity based on the assistance information, and communicating with the network entity using the one or more configurations.

An apparatus for wireless communication at a first UE is described. The apparatus may include a processor, memory coupled with the processor, and instructions stored in the memory. The instructions may be executable by the processor to cause the apparatus to receive assistance information associated with the first UE, where the assistance information is based on situational information from a second UE different from the first UE, determine one or more configurations for communicating with a network entity based on the assistance information, and communicate with the network entity using the one or more configurations.

Another apparatus for wireless communication at a first UE is described. The apparatus may include means for receiving assistance information associated with the first UE, where the assistance information is based on situational information from a second UE different from the first UE, means for determining one or more configurations for communicating with a network entity based on the assistance information, and means for communicating with the network entity using the one or more configurations.

A non-transitory computer-readable medium storing code for wireless communication at a first UE is described. The code may include instructions executable by a processor to receive assistance information associated with the first UE, where the assistance information is based on situational information from a second UE different from the first UE, determine one or more configurations for communicating with a network entity based on the assistance information, and communicate with the network entity using the one or more configurations.

In some examples of the method, apparatuses, and non-transitory computer-readable medium described herein, determining the one or more configurations for communicating with the network entity may include operations, features, means, or instructions for determining, based on the assistance information, a set of directional beams associated with a beam sweeping operation for selecting a beam for communicating with the network entity, the method further including and performing the beam sweeping operation using the set of directional beams, where the communicating with the network entity may be based on the beam sweeping operation.

In some examples of the method, apparatuses, and non-transitory computer-readable medium described herein, determining the one or more configurations for communicating with the network entity may include operations, features, means, or instructions for determining, based on the assistance information, at least one of resources or a modulation and coding scheme for communicating with the network entity, where the communicating with the network entity may be based on the resources, the modulation and coding scheme, or both.

In some examples of the method, apparatuses, and non-transitory computer-readable medium described herein, determining the one or more configurations for communicating with the network entity may include operations, features, means, or instructions for determining, based on the assistance information, one or more power allocation configurations, one or more interference mitigation configurations, or both, for communicating with the network entity, where the communicating with the network entity may be based on the one or more power allocation configurations, the one or more interference mitigation configurations, or both.

In some examples of the method, apparatuses, and non-transitory computer-readable medium described herein, the situational information includes a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports sensing-aided radio access technology (RAT) communications in accordance with one or more aspects of the present disclosure.

FIG. 2 illustrates an example of a network architecture that supports sensing-aided RAT communications in accordance with one or more aspects of the present disclosure.

FIG. 3 illustrates an example of a wireless communications system that supports sensing-aided RAT communications in accordance with one or more aspects of the present disclosure.

FIG. 4 illustrates an example of a wireless communications system that supports sensing-aided RAT communications in accordance with one or more aspects of the present disclosure.

FIG. 5 illustrates an example of a process flow in a system that supports sensing-aided RAT communications in accordance with one or more aspects of the present disclosure.

FIGS. 6 and 7 show block diagrams of devices that support sensing-aided RAT communications in accordance with one or more aspects of the present disclosure.

FIG. 8 shows a block diagram of a communications manager that supports sensing-aided RAT communications in accordance with one or more aspects of the present disclosure.

FIG. 9 shows a diagram of a system including a device that supports sensing-aided RAT communications in accordance with one or more aspects of the present disclosure.

FIGS. 10 and 11 show block diagrams of devices that support sensing-aided RAT communications in accordance with one or more aspects of the present disclosure.

FIG. 12 shows a block diagram of a communications manager that supports sensing-aided RAT communications in accordance with one or more aspects of the present disclosure.

FIG. 13 shows a diagram of a system including a device that supports sensing-aided RAT communications in accordance with one or more aspects of the present disclosure.

FIGS. 14 through 16 show flowcharts illustrating methods that support sensing-aided RAT communications in accordance with one or more aspects of the present disclosure.

### DETAILED DESCRIPTION

Some wireless communications systems may support communications between a UE and a network entity using one or more radio access technologies (RATs). In such systems, it may be challenging for the UE and the network entity to identify suitable configurations for communicating using the one or more RATs. As an example, for millimeter wave (mmW) communications between a UE and a network entity, the UE and the network entity may identify suitable beams to communicate. As such, the UE and the network entity may each support techniques for transmitting and receiving reference signals on multiple beams to identify a beam (e.g., a best beam) for mmW communications. The transmission and reception of reference signals on multiple beams may be referred to as beam sweeping. If, however, the UE is constantly moving or changing positions, the UE and the network entity may repeatedly perform beam sweeping procedures to identify suitable beams for mmW communications, resulting in relatively high overhead and increased power consumption.

As described herein, a UE and a network entity in a wireless communications system may support efficient techniques for identifying configurations for communicating using one or more RATs. In particular, the described techniques provide for using situational information sent by a first UE to a first network entity to aid in communications between a second UE and a second network entity. The first network entity may receive the situational information from the first UE and may generate assistance information associated with the second UE based on the situational information. The situational information may include sensing data collected at the first UE and may, in some examples, include a position, velocity, acceleration, or the like, associated with the second UE and other UEs surrounding the second UE. The first network entity may then provide the assistance information to the second network entity, the second UE, or both, and the second UE and second network entity may use the assistance information to identify suitable configurations for communicating with each other.

In one example, the second network entity, the second UE, or both, may use the assistance information to narrow a range (e.g., narrow a number of directional beams) of one or more beam sweeping procedures used to identify suitable beams for mmW communications, resulting in relatively reduced overhead and decreased power consumption at the second network entity and the second UE. In another example, the second network entity, the second UE, or both may use the assistance information for handover prediction to allow for efficient transitioning from communicating with the second network entity to communicating with another network entity. In yet another example, the second network entity, the second UE, or both may use the assistance information to identify suitable configurations (e.g., transmit power, modulation and coding scheme (MCS), resources, or the like) for mmW communications, resulting in relatively reduced overhead (e.g., from fewer retransmissions) and improved throughput.

Aspects of the disclosure are initially described in the context of wireless communications systems. Examples of processes and signaling exchanges that support sensing-aided RAT communications are then described. Aspects of the disclosure are further illustrated by and described with reference to apparatus diagrams, system diagrams, and flowcharts that relate to sensing-aided RAT communications.

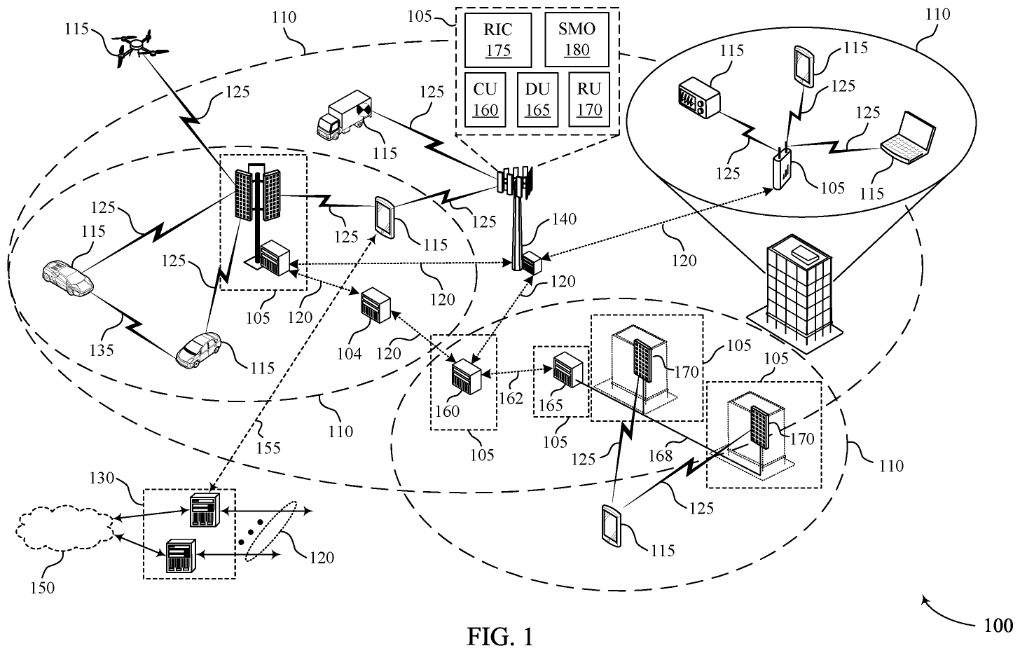

FIG. 1 illustrates an example of a wireless communications system 100 that supports sensing-aided RAT communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In the case of the techniques described herein applied in the context of a disaggregated RAN architecture, one or more components of the disaggregated RAN architecture may be configured to support sensing-aided RAT communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or non-precoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

As mentioned, the wireless communications system 100 may be an example of an NR system and may support fifth generation (5G) communications. In 5G communications and other communications, mmW may be one of multiple technologies supported to increase the data rate of the communications. To overcome poor propagation characteristics associated with mmW communications, it may be appropriate for a UE 115 or a network entity 105 to use a number of antennas to form narrow beams for communications. Further, it may be appropriate for the UE 115 and the network entity 105 to attain beam alignment for mmW communications (e.g., support techniques for beam management, beam selection, or the like). The mmW channel properties may be relatively more deterministic given a certain environment geometry (e.g., compared to lower frequency channels), and a UE 115 or a network entity 105 may identify suitable beams to communicate with each other based on the mmW channel properties.

In some implementations, a UE 115 and a network entity 105 may perform an exhaustive search-based beam sweeping procedure (e.g., sweeping through every available beam or a wide range of beams) to identify one or more suitable beams for communicating with each other. However, the exhaustive search-based beam sweeping procedure may cause relatively increased overhead (e.g., take a relatively long amount of time) for both initial beam establishment (e.g., identifying an initial beam used for mmW communications) and beam tracking procedures (e.g., updating a beam used for mmW communications). In some cases (e.g., with the emergence of wireless technologies in the automotive industry and V2X technologies), some vehicles (e.g., autonomous vehicles, which may also be referred to as self-driving vehicles, driverless cars, ego vehicles, ego cars, or other similar terminology) may be equipped with sensors like satellite navigation, radars, light detection and ranging radars (LiDARs), cameras, or the like. Further, there may be techniques for supporting beam tracking for mmW systems using deep learning or machine learning approaches (e.g., with relatively good evaluation results). Given these sensors and techniques for supporting beam tracking, a UE 115, a network entity 105, or both in wireless communications system 100 may support efficient techniques for identifying configurations for communicating with each other.

For instance, wireless communications system 100 may support efficient techniques for using a wide coverage provider network entity 105 (e.g., a sub-6 GHz network entity) to assist mmW network entities 105 in communications with one or more in-vehicle UEs 115 (e.g., a UEs 115 located in a vehicle) or other UEs 115. In particular, a first UE 115 and a first network entity 105 in the wireless communications system 100 may support efficient techniques for identifying configurations for communicating using one or more RATs, and a second UE 115 and a second network entity 105 may support efficient techniques for assisting the first UE 115 and the first network entity 105 in identifying the configurations. The described techniques may be referred to as sensing-aided communication. In an example, a wide coverage provider network entity 105 may facilitate an efficient beam tracking procedure to reduce the overhead of beam tracking at a mmW network entity 105 or a UE 115, or both. Further, the wide coverage provider network entity 105 may help provide a robust wireless link to a UE 115 (e.g., for mmW communications) based on sensing data collected from an ego vehicle or surrounding intelligent onboard units (OBUs) or roadside units (RSUs).

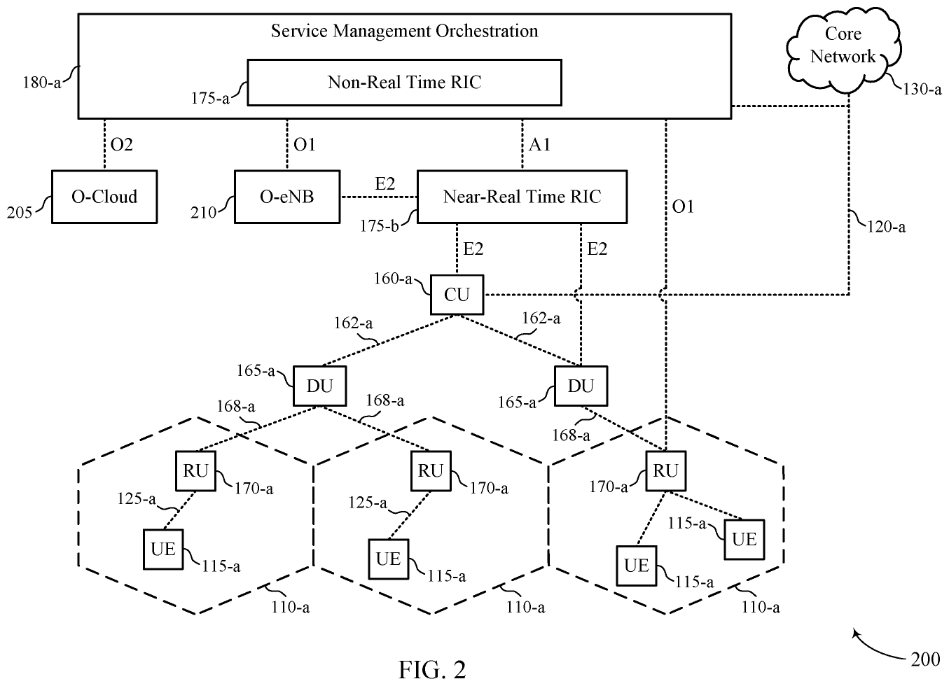

FIG. 2 illustrates an example of a network architecture 200 that (e.g., a disaggregated base station architecture, a disaggregated RAN architecture) that supports sensing-aided RAT communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some aspects, the network architecture 200 may support efficient techniques for identifying configurations for communicating using one or more RATs. In particular, the network architecture 200 may use situational information sent by a first UE 115 to a first network entity 105 to aid in communications between a second UE 115 and a second network entity 105. The first network entity 105 and the second network entity 105 may refer to one or more of the CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210. The first network entity 105 may receive the situational information from the first UE 115 and may generate assistance information associated with the second UE 115 based on the situational information. The situational information may include sensing data collected at the first UE 115 and may, in some examples, include a position, velocity, acceleration, or the like, associated with the second UE 115 and other UEs 115 surrounding the second UE 115. The first network entity 105 may then provide the assistance information to the second network entity 105, the second UE 115, or both, and the second UE 115 and second network entity 105 may use the assistance information to identify suitable configurations for communicating with each other.

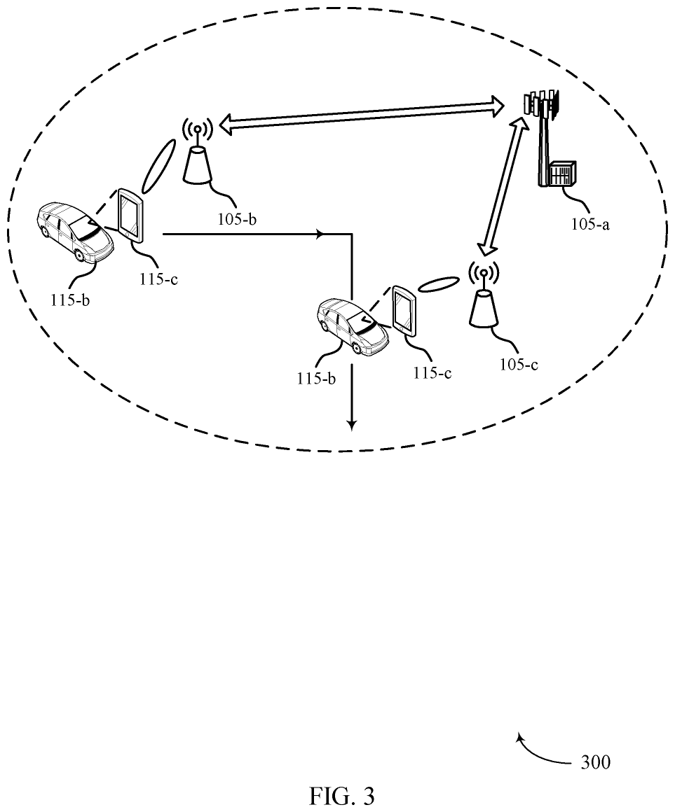

FIG. 3 illustrates an example of a wireless communications system 300 that supports sensing-aided RAT communications in accordance with one or more aspects of the present disclosure. The wireless communications system 300 includes a UE 115-b and a UE 115-c, which may be examples of UEs 115 described with reference to FIG. 1. The wireless communications system 300 also includes a network entity 105-a, a network entity 105-b, and a network entity 105-c, which may be examples of network entities 105 described with reference to FIG. 1. The wireless communications system 300 may implement aspects of the wireless communications system 100 or network architecture 200. For example, the UE 115-c, the network entity 105-b, and the network entity 105-c in wireless communications system 300 may support efficient techniques for identifying configurations for communicating using one or more RATs, and the UE 115-b and the network entity 105-a may support efficient techniques for assisting the UE 115-c, the network entity 105-b, and the network entity 105-c in identifying the configurations.

In wireless communications system 300 (e.g., a 5G network), there may be a sub-6 GHz network entity (e.g., network entity 105-a) and several mmW network entities (e.g., network entity 105-b and network entity 105-c) providing wireless services in a certain area. In an example, the network entity 105-a may provide relatively wide wireless coverage, and the network entity 105-b and the network entity 105-c may enhance peak throughput for some UEs 115 (e.g., in-vehicle UEs 115, UEs 115 that are located in or in close proximity to a vehicle). The UE 115-b (e.g., vehicle) depicted in FIG. 3 may be RRC connected with the network entity 105-a (e.g., the sub-6 GHz network entity). The UE 115-b may be equipped with, for example, a modem (e.g., a 5G modem) and one or more antennas mounted on the top, front, or rear of the UE 115-b. There may be various types of sensors such as radars and cameras also equipped in the UE 115-b (e.g., for autonomous driving purposes). Further, there may be at least one UE 115-c in the UE 115-b providing advanced applications for passengers in the UE 115-b (e.g., entertainment, high-resolution movie downloads, or the like).

In such a scenario where a UE 115-c may be close to a UE 115-b, the UE 115-c may be paired or linked to the UE 115-b, and sensing data collected by the UE 115-b may be used to aid communications at the UE 115-c. Such techniques may be referred to as sensing-aided communications or sensing-aided cross-RAT communications (e.g., because the UE 115-b may be connected to a sub-6 GHz network entity 105-a and the UE 115-c may be connected to a mmW network entity 105). In sensing-aided cross-RAT communications, sensors equipped in the UE 115-b or sensors equipped in other UEs 115 (e.g., sensors equipped in vehicles) may collect environmental information for autonomous driving. This environmental information may be referred to as sensing data. The sensing data may then be used to derive the location of objects and for motional predictions, which may then be leveraged for wireless communications.

To facilitate sensing-aided communications, the UE 115-b may report (fusional) sensing data to the network entity 105-a via a sub-6 GHz band. If the sensing data is collected at or based on data collected at the UE 115-b and other UEs 115, the sensing data may be referred to as fusional sensing data. The network entity 105-a may then indicate a location of the UE 115-c or other information associated with the UE 115-c to a serving network entity 105 of the UE 115-c (e.g., the network entity 105-b or the network entity 105-c) for communications with the UE 115-c (e.g., the nearest mmW network entity). The serving network entity 105 may use the location of the UE 115-c or other information associated with the UE 115-c for beam tracking or to identify other coverage enhancement instructions (e.g., for location-based serving cell selection, handover prediction, serving beam instruction). Additionally, or alternatively, the network entity 105-a may explicitly or implicitly provide location information of the serving network entity 105 to the UE 115-c. The serving network entity 105 may then allocate adequate resources and identify suitable beams or configurations (e.g., retransmission times, channel state information (CSI) predictions) based on the information received from the network entity 105-a to enhance communications with the UE 115-c.

As an illustrative example, the UE 115-c may be located inside of the UE 115-b (e.g., a vehicle), which may be in motion along a particular path, route, or course at some speed. The UE 115-b may collect sensing data (e.g., over time) using one or more sensors or other instruments supported by the UE 115-b, and the sensing data may be associated with the speed, position, acceleration, direction of motion, or other parameters associated with the UE 115-b and/or an environment surrounding the UE 115-b. In any case, the UE 115-b may transmit a message to the network entity 105-a that includes situational information. The network entity 105-a may, in turn, use the situational information to assist other devices in the wireless communications system 300. For instance, the network entity 105-a may provide assistance information to one or both of the network entities 105-b or 105-c, which may be used to facilitate efficient beam management procedures or other procedures (e.g., handover to the network entity 105-c while the UE 115-b is in motion). Additionally, or alternatively, the network entity 105-a may provide the assistance information to the UE 115-c, which may be similarly used to enhance beam management or other processes.

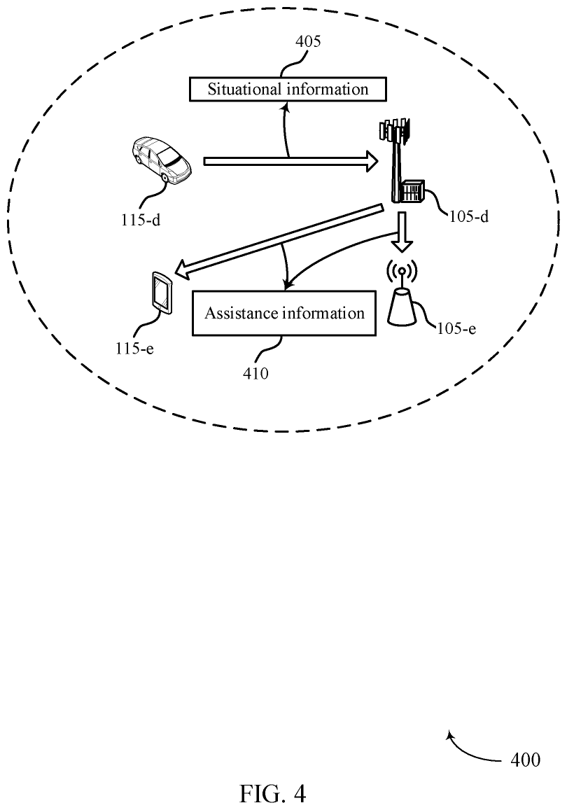

FIG. 4 illustrates an example of a wireless communications system 400 that supports sensing-aided RAT communications in accordance with one or more aspects of the present disclosure. The wireless communications system 400 includes a UE 115-d and a UE 115-e, which may be examples of UEs 115 described with reference to FIGS. 1 and 2. The wireless communications system 400 also includes a network entity 105-d and a network entity 105-e, which may be examples of network entities 105 described with reference to FIGS. 1 and 2.

The wireless communications system 400 may implement aspects of the wireless communications system 100, network architecture 200, or wireless communications system 300. For example, the UE 115-d, the UE 115-e, the network entity 105-d, and the network entity 105-e in the wireless communications system 400 may support efficient techniques for identifying configurations for communicating using one or more RATs, and the UE 115-d and the network entity 105-d may support efficient techniques for assisting the UE 115-e and the network entity 105-e in identifying the configurations. These techniques may be referred to as sensing-aided RAT communications or sensing-aided cross-RAT communications and may reduce the complexity for supporting mmW communications at the UE 115-e, reduce the latency of beam selection at the UE 115-e and the network entity 105-e, and, in some cases, improve coverage (e.g., if used to schedule coordinated multipoint (COMP) communications with the UE 115-e).

The UE 115-d may report sensing data or situational information 405 (e.g., situational awareness information) to the network entity 105-d via a sub-6 GHz band. The sensing data or situational information 405 may be based on a vehicle's sensors or fused data from sensor sharing messages received from surrounding vehicles or infrastructures (e.g., RSUs). In some examples, the sensing data or situational information 405 may include a current location of the UE 115-e and a propagation loss associated with communicating with the UE 115-e (e.g., from an in-vehicle scenario). In some examples, the sensing data or situational information 405 may include a velocity, direction, acceleration, or other motional information of the UE 115-e. In some examples, the sensing data or situational information 405 may include location or other motional information of objects surrounding the UE 115-e, potential blockages in the future (e.g., in a future point in time), or the like.

The network entity 105-d may then forward a location of the UE 115-e or other information associated with the UE 115-e to the network entity 105-e (e.g., the nearest mmW network entity). In some cases, the network entity 105-d may predict a future location of the UE 115-e (e.g., using machine learning) and instruct the network entity 105-e of the future location of the UE 115-e in advance (e.g., in advance of the UE 115-e arriving at the future location). Additionally, or alternatively, the network entity 105-d may provide, based on the sensing data or situational information 405, recommended or restricted beam directions to the network entity 105-e (e.g., selected serving mmW network entity 105-e) to minimize beam tracking efforts. Further, in some examples, the network entity 105-d may select, based on the sensing data or situational information 405, more than one serving network entities or cells to enable downlink COMP to the UE 115-e for better coverage (e.g., when the UE 115-e is in a cell edge area).

The information transmitted by the network entity 105-d to the network entity 105-e may be referred to as assistance information 410. The network entity 105-d may receive the sensing data or situational information 405 from the UE 115-e (e.g., over a first RAT, such as a sub-6 GHz RAT) and generate the assistance information 410 based on the sensing data or the situational information 405. In some cases, the network entity 105-d may select or identify a serving cell to communicate with or in communications with the UE 115-e (e.g., over a second RAT), and the network entity 105-d may identify a beam set recommendation or restriction, a link status indication, or the like. to provide to the network entity 105-e to aid communications between the network entity 105-e and the UE 115-e. The network entity 105-d may transmit motional information of the UE 115-e, a beam set recommendation or restriction, a link status indication, or the like, in the assistance information 410 to the network entity 105-e. The network entity 105-e may then use the assistance information 410 to determine a sweeping beam set for initial beam selection and beam tracking or to select a resource allocation, an MCS, or other parameters, for communications with the UE 115-e.

In some aspects, the network entity 105-d may also transmit assistance information 410 to the UE 115-e based on the sensing data or situational information 405 received from the UE 115-d. That is, after selecting or identifying the network entity 105-e serving the UE 115-e (e.g., serving cell associated with the network entity 105-e), the network entity 105-d may signal information associated with the network entity 105-e to the UE 115-e. The assistance information 410 transmitted by the network entity 105-d to the UE 115-e may include explicit location information of the network entity 105-e, a recommended receiver-side beam set (e.g., without explicit location information of the network entity 105-e) for receiving data from the network entity 105-e, a restricted sweeping beam set to minimize beam sweeping processes at the UE 115-e, among other information.

Additionally, or alternatively, the network entity 105-d may inform the UE 115-e of other wireless link situational information in the assistance information 410. In some examples, the assistance information 410 transmitted to the UE 115-e may include an indication of a potential handover to another network entity 105 or a measurement indication (e.g., demand) for another network entity 105. In some examples, the assistance information 410 transmitted to the UE 115-e may include a warning of a potential increase in interference or measurement demands from nearby network entities 105 (e.g., mmW network entities 105). In some examples, the assistance information 410 transmitted to the UE 115-e may include link status information to assist the UE 115-e with resource management and configuration determination (e.g., power allocation enhancements in a certain direction or of a certain beam, interference mitigation at a certain point in time).

Once the network entity 105-e receives the assistance information 410 from the network entity 105-d, the network entity 105-e may allocate adequate resources for communications with the UE 115-e. The network entity 105-e may also identify directional beams or determine configurations (e.g., retransmission times, CSI predictions, or the like) for communications with the UE 115-e to enhance the communications. In some examples, the network entity 105-e may schedule a beamforming set for the UE 115-e to conduct beam sweeping (e.g., transmit the beamforming set to the UE 115-e). In some examples, the network entity 105-e may schedule beamformed CSI-RSs for the UE 115-e based on the assistance information 410. The precoder generation of the CSI-RSs may be based on a directional indication or explicit beam indication in the assistance information 410 (e.g., based on the sensing data or the situational information 405).

In some examples, the network entity 105-e may set a larger maximum retransmission time for transmitting a packet to the UE 115-e if the network entity 105-e determines that the UE 115-e is at a cell-edge or a transmit power of the network entity 105-e is power restricted. For instance, the network entity 105-e may determine a maximum retransmission time or maximum quantity of retransmissions for transmitting to the UE 115-e based on the assistance information 410, and the network entity 105-e may transmit an indication of the maximum retransmission time or maximum quantity of retransmissions to the UE 115-e. In some examples, the network entity 105-e may select initial or default physical layer resource configurations (e.g., MCS, MU-MIMO configurations) for communications with the UE 115-e based on the assistance information 410 from the network entity 105-d.

Although the examples described herein are related to a cross-RAT sensing-aided scenario where the network entity 105-d and the network entity 105-e are associated with different RATs, the described techniques for sensing-aided communications may apply for other scenarios. For instance, a sub-6 GHz cell may assist another sub-6 GHz cell, or one sub-6 GHz primary cell may assist another sub-6 GHz secondary cell using the described techniques. In some cases, the sensing information or situational information 405 provided by the UE 115-d to the network entity 105-d may be collected from one or more intelligent UEs 115 (e.g., vehicles). Additionally, or alternatively, a sub-6 GHz or mmW network entity 105 may be equipped with cameras that may have a certain level of sensibility, and the network entity 105-e or the UE 115-e may identify suitable configurations for communicating based on sensing information from the sub-6 GHz or mmW network entity 105. In some examples, the UE 115-d and the UE 115-e may also establish a wireless connection and may directly communicate such that the UE 115-d may assist the UE 115-e (e.g., provide sensing data or situational information 405) for communications between the UE 115-e and the network entity 105-e.

In some cases, the prediction of vehicle motion parameters (e.g., motion parameters of the UE 115-d) may be different for different cases (e.g., based on an implementation of the network entity 105-d). In some cases, the network entity 105-d may predict the vehicle motion parameters (e.g., motion parameters of the UE 115-d or the UE 115-e) to include in the assistance information 410 or to use to generate the assistance information 410. In other cases, the network entity 105-e may predict the vehicle motion parameters based on the assistance information 410 received from the network entity 105-d. In one example, the network entity 105-d or the network entity 105-e may predict vehicle motion based on a reported status (e.g., situational information 405 or assistance information 410) using a motion model (e.g., a Kalman filter or other models). In another example, the UE 115-d may transmit a trained model to the network entity 105-d, and the network entity 105-d may use the trained model to predict vehicle motion or the network entity 105-d may provide the trained model to the network entity 105-e such that the network entity 105-e may use the trained model to predict vehicle motion.

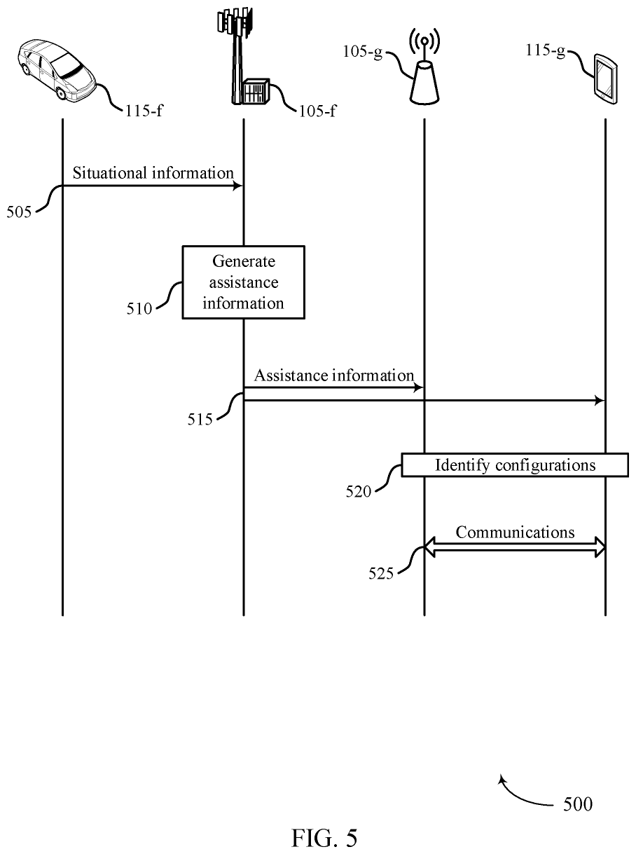

FIG. 5 illustrates an example of a process flow 500 in a system that supports sensing-aided RAT communications in accordance with one or more aspects of the present disclosure. The process flow 500 includes a UE 115-f and a UE 115-g, which may be examples of UEs 115 described with reference to FIGS. 1-3. The process flow 500 also includes a network entity 105-f and a network entity 105-g, which may be examples of network entities 105 described with reference to FIGS. 1-3. The network entity 105-f and the network entity 105-g may be associated with different RATs or a same RAT. The process flow 500 may implement aspects of the wireless communications system 100, the network architecture 200, the wireless communications system 300, or the wireless communications system 400. For example, devices in the process flow 500 may support efficient techniques for identifying configurations for communicating using one or more RATs.

In the following description of the process flow 500, the signaling exchanged between the UE 115-f, the network entity 105-f, the network entity 105-g, and the UE 115-g may be exchanged in a different order than the example order shown, or the operations performed by the UE 115-f, the network entity 105-f, the network entity 105-g, and the UE 115-g may be performed in different orders or at different times. Some operations may also be omitted from the process flow 500, and other operations may be added to the process flow 500.

At 505, the UE 115-f may transmit situational information to the network entity 105-f. The situational information may be sensing data collected at the UE 115-f or may be based on the sensing data collected at the UE 115-f. The sensing data may be collected from one or more sensors at the UE 115-f or proximity sensors close to the UE 115-f (e.g., sensors of nearby vehicles or RSUs). In some examples, the situational information may include a size, position, velocity, movement direction, speed, acceleration, motional information, or other information, of the UE 115-f, other UEs 115, or moving or static objects. Further, the situational information may include a location of the UE 115-f, other UEs 115, or moving or static objects or a propagation loss associated with communicating with the UE 115-g. The UE 115-f may transmit situational information to the network entity 105-f periodically, aperiodically, or semi-persistently.

At 510, the network entity 105-f may generate assistance information associated with the UE 115-g based on the situational information received at 505. The assistance information may include one or more parameters indicative of a condition of the UE 115-g (e.g., propagation loss or link status). For instance, the assistance information may include a portion or all of the situational information (e.g., for transparent forwarding of the assistance information to the network entity 105-g and the UE 115-g). Alternatively, the assistance information may include instructions or recommendations (e.g., beam, resource allocation, transmit power, MCS, or other recommendations) extracted or processed from the situational information.

At 515, the network entity 105-f may transmit the assistance information to the network entity 105-g, the UE 115-g, or both. In one example, the network entity 105-f may determine a first position of the UE 115-g based on the situational information and a second position of the network entity 105-g, and the network entity 105-f may transmit the assistance information to the network entity 105-g if a distance between the first position and the second position satisfies a distance threshold. In this example, the assistance information may include handover or cell selection information and may enable a handover to the network entity 105-g or cell selection of the network entity 105-g. In another example, the network entity 105-f may determine that the network entity 105-g is associated with a serving cell for communicating with the UE 115-g, and the network entity 105-f may transmit the assistance information to the network entity 105-g based on the network entity 105-g being associated with the serving cell. In yet another example, the network entity 105-f may select one or more network entities 105 including the network entity 105-g for COMP communications with the UE 115-g, and the network entity 105-f may coordinate communications between the UE 115-g and the selected one or more network entities based on the assistance information. The network entity 105-f may transmit assistance information to the network entity 105-g, the UE 115-g, or both periodically, aperiodically (e.g., triggered for high-throughput or high-priority applications or triggered by communication failure), or semi-persistently.

In some aspects, the network entity 105-f may identify one or more recommended or restricted beam directions for beam selection at the network entity 105-g, the UE 115-g, or both based on the situational information, and the network entity 105-f may transmit the one or more recommended or restricted beam directions for beam selection to the network entity 105-g, the UE 115-g, or both. The recommended or restricted beam directions may be referred to as beam set instructions and may be in different forms. For instance, the beam direction or beam set instructions may include an angle of arrival (AoA) for transmissions to the network entity 105-g, the UE 115-g, or both, an angle of departure (AoD) for transmissions from the network entity 105-g, the UE 115-g, or both, or beam indices (e.g., if there is pre-coordination on beam management between the network entity 105-f and the network entity 105-g). In other aspects, the network entity 105-f may predict a future position of the UE 115-g based on the situational information, and the network entity 105-f may transmit a message indicating the predicted future position to the network entity 105-g, the UE 115-g, or both.

In some cases, the network entity 105-f may transmit a first portion of the assistance information to the network entity 105-g and a second portion of the assistance information to the UE 115-g. In other cases, the network entity 105-f may transmit the same portion or all of the assistance information to the network entity 105-g and the UE 115-g. In any case, a portion or all of the assistance information transmitted to the network entity 105-g, the UE 115-g, or both may include one or more recommended or restricted beam directions for beam selection at the network entity 105-g, the UE 115-g, or both or a range of a beam sweep for the network entity 105-g, the UE 115-g, or both to perform during beam selection. Alternatively, a portion or all of the assistance information transmitted to the network entity 105-g, the UE 115-g, or both may include handover information associated with one or more other network entities 105, measurements associated with the other network entities 105, an indication of interference from nearby network entities 105, or measurement demands from nearby network entities 105.

At 520, the network entity 105-g, the UE 115-g, or both may identify configurations for communicating with each other based on the assistance information received from the network entity 105-f. In one example, the network entity 105-g, the UE 115-g, or both may determine, based on the assistance information, a set of directional beams associated with a beam sweeping operation for selecting a beam for communicating with each other, and the network entity 105-g, the UE 115-g, or both may perform the beam sweeping operation using the set of directional beams. In another example, the network entity 105-g, the UE 115-g, or both may determine, based on the assistance information, at least one of resources or an MCS for communicating with each other. In yet another example, the network entity 105-g, the UE 115-g, or both may determine, based on the assistance information, one or more power allocation configurations, one or more interference mitigation configurations, or both for communicating with each other. In some cases, the network entity 105-g may transmit, based on the assistance information, control information to the UE 115-g configuring one or more of a set of directional beams associated with a beam sweeping operation, reference signal transmissions, or a threshold number of retransmissions for communicating with the UE 115-g. At 525, the network entity 105-g and the UE 115-g may then communicate using the configurations identified at 520.

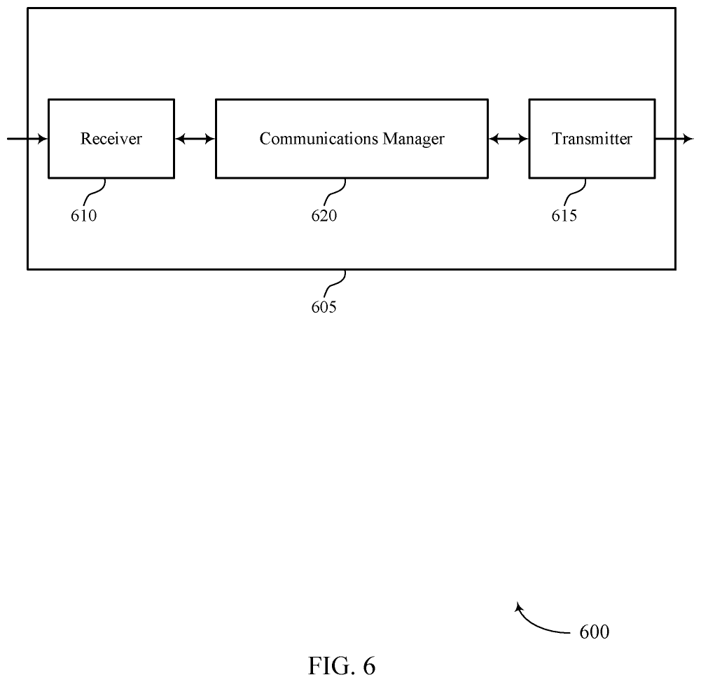

FIG. 6 shows a block diagram 600 of a device 605 that supports sensing-aided RAT communications in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of sensing-aided RAT communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first network entity in accordance with examples as disclosed herein. For example, the communications manager 620 may be configured as or otherwise support a means for receiving situational information from a first UE. The communications manager 620 may be configured as or otherwise support a means for generating assistance information associated with a second UE different from the first UE, the assistance information being based on the situational information and including one or more parameters indicative of a condition of the second UE, the second UE being linked to the first UE. The communications manager 620 may be configured as or otherwise support a means for transmitting at least a portion of the assistance information to a second network entity different from the first network entity.

Additionally, or alternatively, the communications manager 620 may support wireless communication at a first network entity in accordance with examples as disclosed herein. For example, the communications manager 620 may be configured as or otherwise support a means for receiving, from a second network entity, assistance information associated with a first UE, where the assistance information is based on situational information from a second UE different from the first UE. The communications manager 620 may be configured as or otherwise support a means for determining one or more configurations for communicating with the first UE based on the assistance information received from the second network entity. The communications manager 620 may be configured as or otherwise support a means for communicating with the first UE using the one or more configurations.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources. Because the device 605 may receive, from a network entity, assistance information generated based on sensing data or situational information, the device 605 may be able to identify suitable configurations for communicating with a UE based on the assistance information. As a result, beam management at the device 605 may be improved and retransmissions from the device 605 may be avoided or reduced (e.g., resulting in the reduced processing, the reduced power consumption, and the more efficient utilization of communication resources).

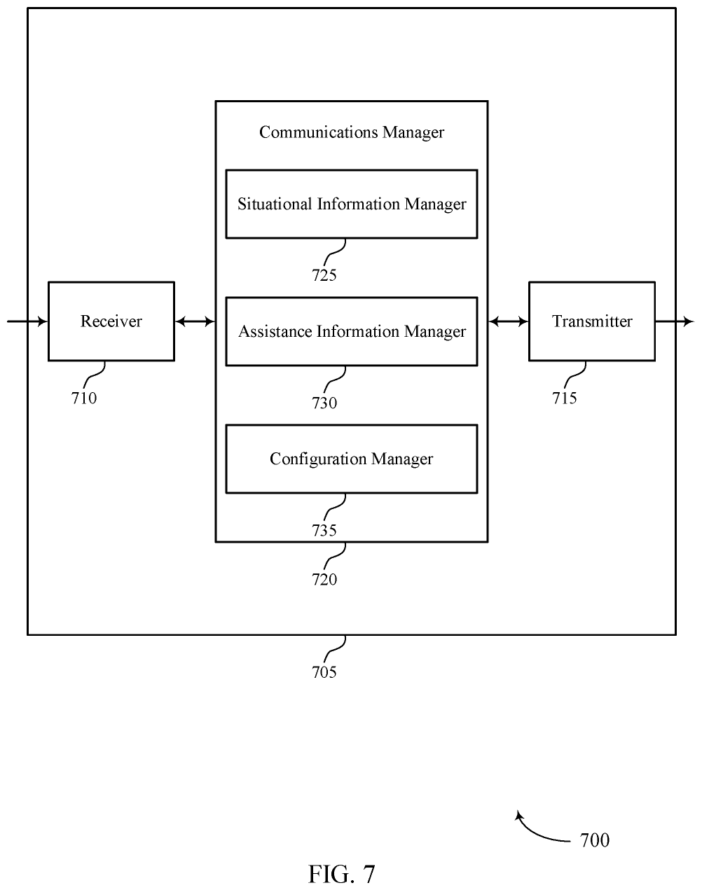

FIG. 7 shows a block diagram 700 of a device 705 that supports sensing-aided RAT communications in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of sensing-aided RAT communications as described herein. For example, the communications manager 720 may include a situational information manager 725, an assistance information manager 730, a configuration manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network entity in accordance with examples as disclosed herein. The situational information manager 725 may be configured as or otherwise support a means for receiving situational information from a first UE. The assistance information manager 730 may be configured as or otherwise support a means for generating assistance information associated with a second UE different from the first UE, the assistance information being based on the situational information and including one or more parameters indicative of a condition of the second UE, the second UE being linked to the first UE. The assistance information manager 730 may be configured as or otherwise support a means for transmitting at least a portion of the assistance information to a second network entity different from the first network entity.

Additionally, or alternatively, the communications manager 720 may support wireless communication at a first network entity in accordance with examples as disclosed herein. The assistance information manager 730 may be configured as or otherwise support a means for receiving, from a second network entity, assistance information associated with a first UE, where the assistance information is based on situational information from a second UE different from the first UE. The configuration manager 735 may be configured as or otherwise support a means for determining one or more configurations for communicating with the first UE based on the assistance information received from the second network entity. The configuration manager 735 may be configured as or otherwise support a means for communicating with the first UE using the one or more configurations.

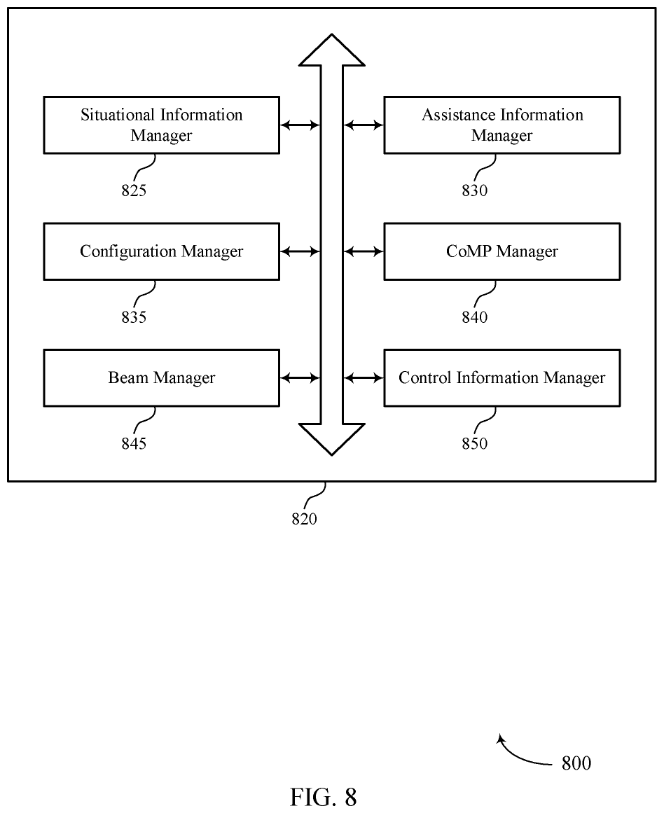

FIG. 8 shows a block diagram 800 of a communications manager 820 that supports sensing-aided RAT communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of sensing-aided RAT communications as described herein. For example, the communications manager 820 may include a situational information manager 825, an assistance information manager 830, a configuration manager 835, a COMP manager 840, a beam manager 845, a control information manager 850, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a first network entity in accordance with examples as disclosed herein. The situational information manager 825 may be configured as or otherwise support a means for receiving situational information from a first UE. The assistance information manager 830 may be configured as or otherwise support a means for generating assistance information associated with a second UE different from the first UE, the assistance information being based on the situational information and including one or more parameters indicative of a condition of the second UE, the second UE being linked to the first UE. In some examples, the assistance information manager 830 may be configured as or otherwise support a means for transmitting at least a portion of the assistance information to a second network entity different from the first network entity.

In some examples, the assistance information manager 830 may be configured as or otherwise support a means for determining a first position of the second UE based on the situational information. In some examples, the assistance information manager 830 may be configured as or otherwise support a means for determining a second position of the second network entity, where transmitting the assistance information to the second network entity is based on a distance between the first position and the second position satisfying a distance threshold.

In some examples, to support generating the assistance information, the assistance information manager 830 may be configured as or otherwise support a means for identifying one or more recommended or restricted beam directions for beam selection at the second network entity based on the situational information, and where transmitting at least the portion of the assistance information to the second network entity includes. In some examples, to support generating the assistance information, the assistance information manager 830 may be configured as or otherwise support a means for transmitting the one or more recommended or restricted beam directions for beam selection to the second network entity.

In some examples, the assistance information manager 830 may be configured as or otherwise support a means for transmitting at least another portion of the assistance information to the second UE to aid in communications between the second UE and the second network entity.

In some examples, the other portion of the assistance information includes one or more recommended or restricted beam directions for beam selection at the second UE, a range of a beam sweep for the second UE to perform during beam selection, or a combination thereof.

In some examples, the other portion of the assistance information includes handover information associated with a third network entity, measurements associated with the third network entity, an indication of interference from nearby network entities, measurement demands from nearby network entities, or a combination thereof.

In some examples, the assistance information manager 830 may be configured as or otherwise support a means for determining that the second network entity is associated with a serving cell for communicating with the second UE, where transmitting the assistance information to the second network entity is based on the determining.

In some examples, the CoMP manager 840 may be configured as or otherwise support a means for selecting one or more network entities including the second network entity for coordinated multipoint communications with the second UE. In some examples, the COMP manager 840 may be configured as or otherwise support a means for coordinating communications between the second UE and the selected one or more network entities based on the assistance information.

In some examples, the assistance information manager 830 may be configured as or otherwise support a means for predicting a future position of the second UE based on the situational information, where transmitting the assistance information to the second network entity includes. In some examples, the assistance information manager 830 may be configured as or otherwise support a means for transmitting a message indicating the predicted future position to the second network entity.

In some examples, the situational information includes a position of the second UE, a propagation loss associated with communications with the second UE, a velocity of the second UE, a movement direction of the second UE, a speed of the second UE, an acceleration of the second UE, a location or other motional information of one or more objects surrounding the second UE, or a combination thereof.

In some examples, the situational information is based on data collected at one or more sensors at the first UE, one or more sensors at one or more other UEs, or a combination thereof.

In some examples, the first network entity and the second network entity are associated with different radio access technologies or a same radio access technology.

Additionally, or alternatively, the communications manager 820 may support wireless communication at a first network entity in accordance with examples as disclosed herein. In some examples, the assistance information manager 830 may be configured as or otherwise support a means for receiving, from a second network entity, assistance information associated with a first UE, where the assistance information is based on situational information from a second UE different from the first UE. The configuration manager 835 may be configured as or otherwise support a means for determining one or more configurations for communicating with the first UE based on the assistance information received from the second network entity. In some examples, the configuration manager 835 may be configured as or otherwise support a means for communicating with the first UE using the one or more configurations.

In some examples, to support determining the one or more configurations for communicating with the first UE, the beam manager 845 may be configured as or otherwise support a means for determining, based on the assistance information, a set of directional beams associated with a beam sweeping operation for selecting a beam for communicating with the first UE. In some examples, to support determining the one or more configurations for communicating with the first UE, the beam manager 845 may be configured as or otherwise support a means for performing the beam sweeping operation using the set of directional beams, where the communicating with the first UE is based on the beam sweeping operation.

In some examples, to support determining the one or more configurations for communicating with the first UE, the configuration manager 835 may be configured as or otherwise support a means for determining, based on the assistance information, at least one of resources or a modulation and coding scheme for communicating with the first UE, where the communicating with the first UE is based on the resources, the modulation and coding scheme, or both.

In some examples, to support determining the one or more configurations for communicating with the first UE, the configuration manager 835 may be configured as or otherwise support a means for determining, based on the assistance information, one or more power allocation configurations, one or more interference mitigation configurations, or both, for communicating with the first UE, where the communicating with the first UE is based on the one or more power allocation configurations, the one or more interference mitigation configurations, or both.

In some examples, the control information manager 850 may be configured as or otherwise support a means for transmitting, based on the assistance information, control information configuring one or more of a set of directional beams associated with a beam sweeping operation, reference signal transmissions, or a threshold number of retransmissions for communicating with the first UE, where the communicating with the first UE is based on the control information.

In some examples, the situational information includes a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

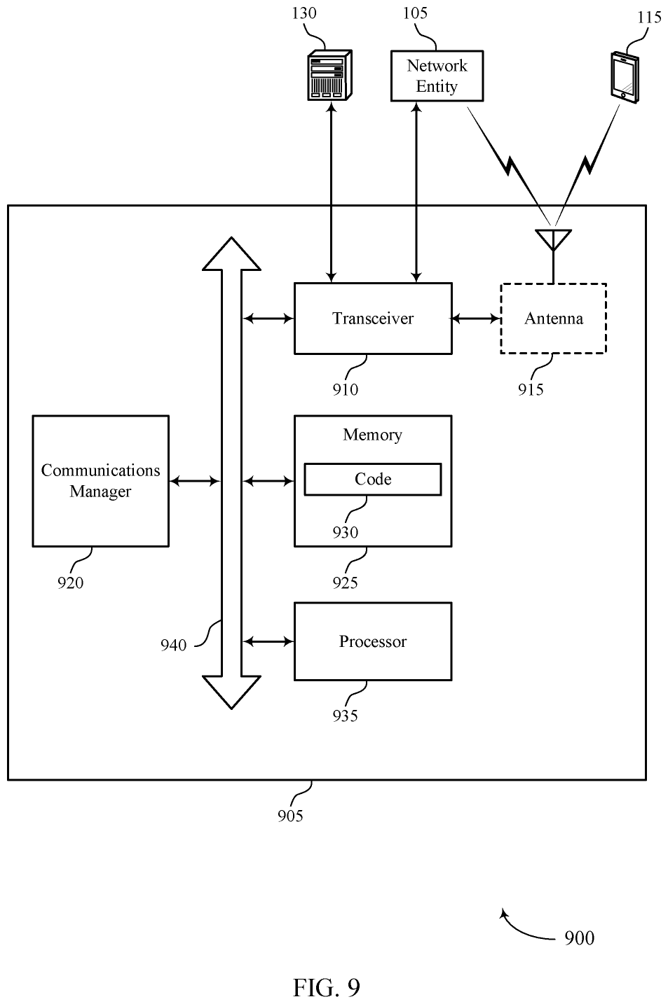

FIG. 9 shows a diagram of a system 900 including a device 905 that supports sensing-aided RAT communications in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. The transceiver 910, or the transceiver 910 and one or more antennas 915 or wired interfaces, where applicable, may be an example of a transmitter 615, a transmitter 715, a receiver 610, a receiver 710, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 925 may include random-access memory (RAM) and read-only memory (ROM). The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting sensing-aided RAT communications). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communication at a first network entity in accordance with examples as disclosed herein. For example, the communications manager 920 may be configured as or otherwise support a means for receiving situational information from a first UE. The communications manager 920 may be configured as or otherwise support a means for generating assistance information associated with a second UE different from the first UE, the assistance information being based on the situational information and including one or more parameters indicative of a condition of the second UE, the second UE being linked to the first UE. The communications manager 920 may be configured as or otherwise support a means for transmitting at least a portion of the assistance information to a second network entity different from the first network entity.

Additionally, or alternatively, the communications manager 920 may support wireless communication at a first network entity in accordance with examples as disclosed herein. For example, the communications manager 920 may be configured as or otherwise support a means for receiving, from a second network entity, assistance information associated with a first UE, where the assistance information is based on situational information from a second UE different from the first UE. The communications manager 920 may be configured as or otherwise support a means for determining one or more configurations for communicating with the first UE based on the assistance information received from the second network entity. The communications manager 920 may be configured as or otherwise support a means for communicating with the first UE using the one or more configurations.

By including or configuring the communications manager 920 in accordance with examples as described herein, the device 905 may support techniques for reduced processing, reduced power consumption, and more efficient utilization of communication resources. Because the device 905 may receive, from a network entity, assistance information generated based on sensing data or situational information, the device 905 may be able to identify suitable configurations for communicating with a UE based on the assistance information. As a result, beam management at the device 905 may be improved and retransmissions from the device 905 may be avoided or reduced (e.g., resulting in the reduced processing, the reduced power consumption, and the more efficient utilization of communication resources).

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of sensing-aided RAT communications as described herein, or the processor 935 and the memory 925 may be otherwise configured to perform or support such operations.

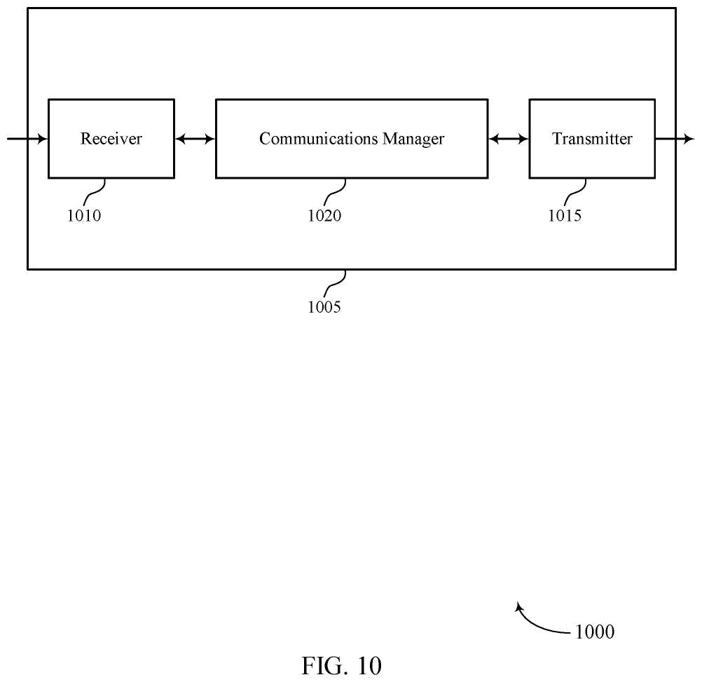

FIG. 10 shows a block diagram 1000 of a device 1005 that supports sensing-aided RAT communications in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to sensing-aided RAT communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sensing-aided RAT communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of sensing-aided RAT communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. For example, the communications manager 1020 may be configured as or otherwise support a means for receiving assistance information associated with the first UE, where the assistance information is based on situational information from a second UE different from the first UE. The communications manager 1020 may be configured as or otherwise support a means for determining one or more configurations for communicating with a network entity based on the assistance information. The communications manager 1020 may be configured as or otherwise support a means for communicating with the network entity using the one or more configurations.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources. Because the device 1005 may receive, from a network entity, assistance information generated based on sensing data or situational information, the device 1005 may be able to identify suitable configurations for communicating with another network entity based on the assistance information. As a result, beam management at the device 1005 may be improved and retransmissions to the device 1005 may be avoided or reduced (e.g., resulting in the reduced processing, the reduced power consumption, and the more efficient utilization of communication resources).

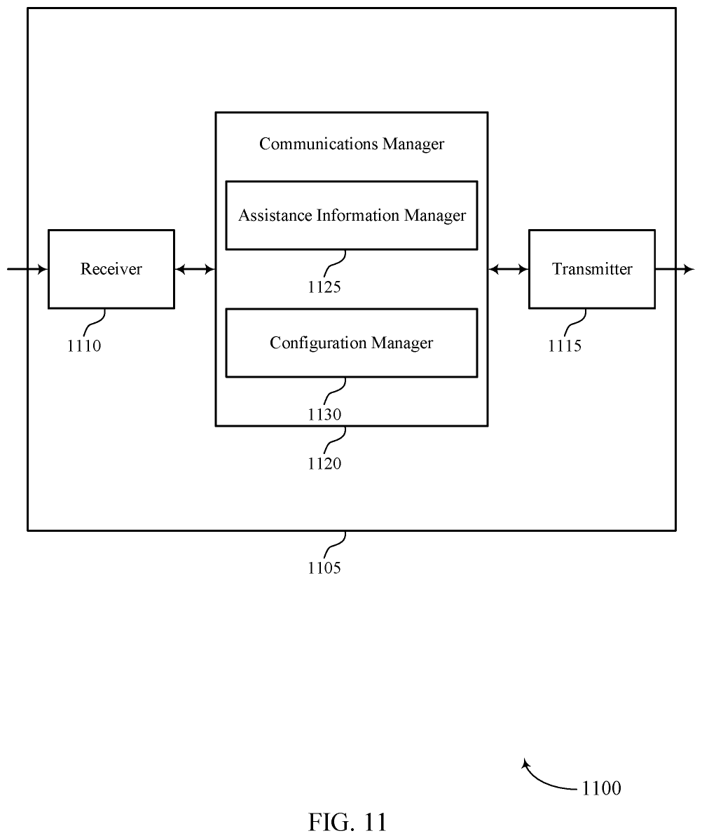

FIG. 11 shows a block diagram 1100 of a device 1105 that supports sensing-aided RAT communications in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to sensing-aided RAT communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to sensing-aided RAT communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of sensing-aided RAT communications as described herein. For example, the communications manager 1120 may include an assistance information manager 1125 a configuration manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first UE in accordance with examples as disclosed herein. The assistance information manager 1125 may be configured as or otherwise support a means for receiving assistance information associated with the first UE, where the assistance information is based on situational information from a second UE different from the first UE. The configuration manager 1130 may be configured as or otherwise support a means for determining one or more configurations for communicating with a network entity based on the assistance information. The configuration manager 1130 may be configured as or otherwise support a means for communicating with the network entity using the one or more configurations.

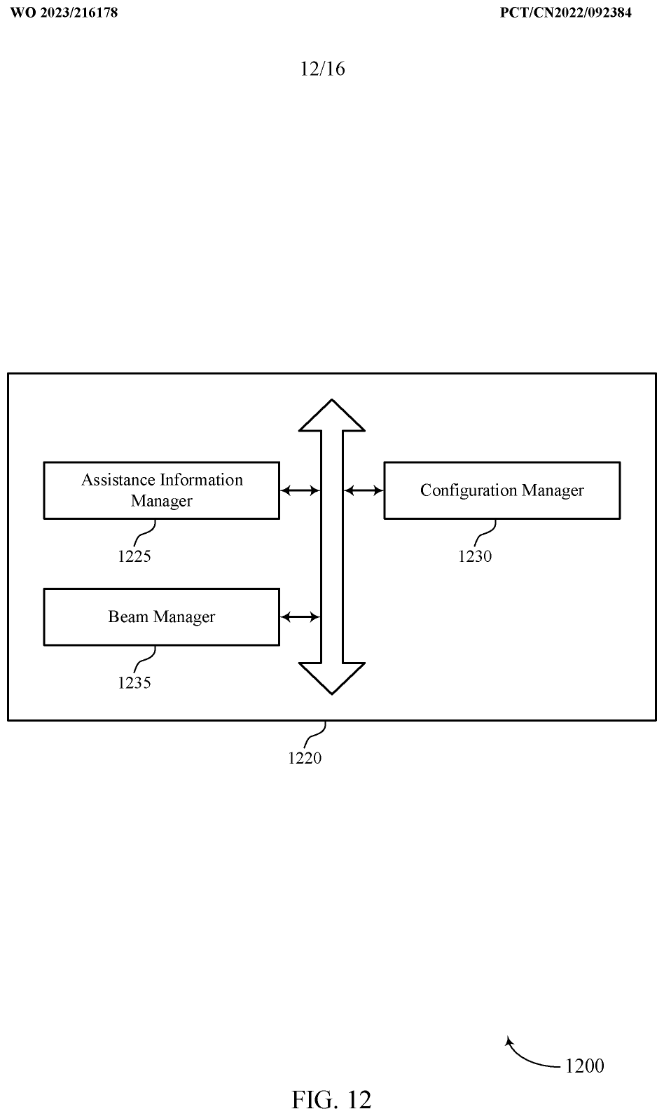

FIG. 12 shows a block diagram 1200 of a communications manager 1220 that supports sensing-aided RAT communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of sensing-aided RAT communications as described herein. For example, the communications manager 1220 may include an assistance information manager 1225, a configuration manager 1230, a beam manager 1235, or any combination thereof. Each of these components may communicate, directly or indirectly, with one another (e.g., via one or more buses).

The communications manager 1220 may support wireless communication at a first UE in accordance with examples as disclosed herein. The assistance information manager 1225 may be configured as or otherwise support a means for receiving assistance information associated with the first UE, where the assistance information is based on situational information from a second UE different from the first UE. The configuration manager 1230 may be configured as or otherwise support a means for determining one or more configurations for communicating with a network entity based on the assistance information. In some examples, the configuration manager 1230 may be configured as or otherwise support a means for communicating with the network entity using the one or more configurations.

In some examples, to support determining the one or more configurations for communicating with the network entity, the beam manager 1235 may be configured as or otherwise support a means for determining, based on the assistance information, a set of directional beams associated with a beam sweeping operation for selecting a beam for communicating with the network entity. In some examples, to support determining the one or more configurations for communicating with the network entity, the beam manager 1235 may be configured as or otherwise support a means for performing the beam sweeping operation using the set of directional beams, where the communicating with the network entity is based on the beam sweeping operation.

In some examples, to support determining the one or more configurations for communicating with the network entity, the configuration manager 1230 may be configured as or otherwise support a means for determining, based on the assistance information, at least one of resources or a modulation and coding scheme for communicating with the network entity, where the communicating with the network entity is based on the resources, the modulation and coding scheme, or both.

In some examples, to support determining the one or more configurations for communicating with the network entity, the configuration manager 1230 may be configured as or otherwise support a means for determining, based on the assistance information, one or more power allocation configurations, one or more interference mitigation configurations, or both, for communicating with the network entity, where the communicating with the network entity is based on the one or more power allocation configurations, the one or more interference mitigation configurations, or both.

In some examples, the situational information includes a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

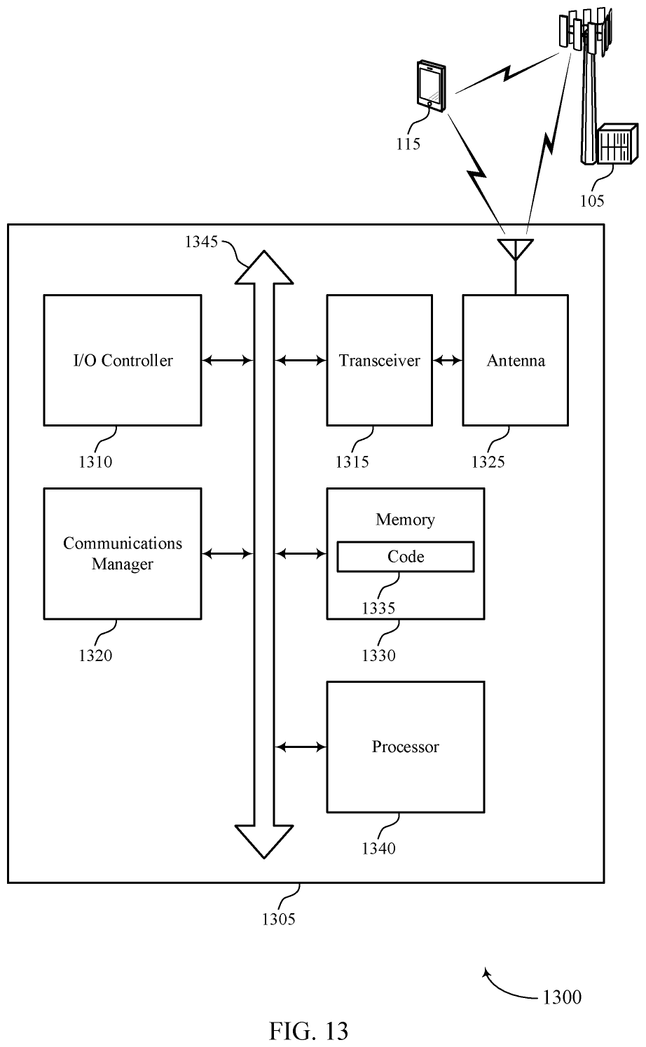

FIG. 13 shows a diagram of a system 1300 including a device 1305 that supports sensing-aided RAT communications in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting sensing-aided RAT communications). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a first UE in accordance with examples as disclosed herein. For example, the communications manager 1320 may be configured as or otherwise support a means for receiving assistance information associated with the first UE, where the assistance information is based on situational information from a second UE different from the first UE. The communications manager 1320 may be configured as or otherwise support a means for determining one or more configurations for communicating with a network entity based on the assistance information. The communications manager 1320 may be configured as or otherwise support a means for communicating with the network entity using the one or more configurations.

By including or configuring the communications manager 1320 in accordance with examples as described herein, the device 1305 may support techniques for reduced processing, reduced power consumption, and more efficient utilization of communication resources. Because the device 1305 may receive, from a network entity, assistance information generated based on sensing data or situational information, the device 1305 may be able to identify suitable configurations for communicating with another network entity based on the assistance information. As a result, beam management at the device 1305 may be improved and retransmissions to the device 1305 may be avoided or reduced (e.g., resulting in the reduced processing, the reduced power consumption, and the more efficient utilization of communication resources).

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of sensing-aided RAT communications as described herein, or the processor 1340 and the memory 1330 may be otherwise configured to perform or support such operations.

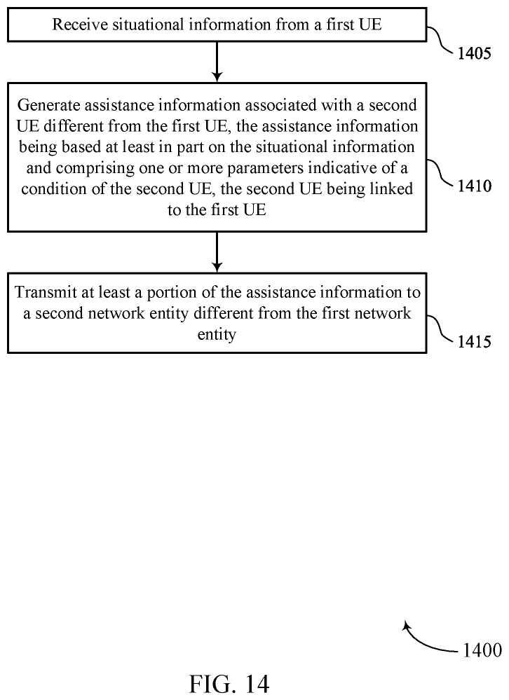

FIG. 14 shows a flowchart illustrating a method 1400 that supports sensing-aided RAT communications in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include receiving situational information from a first UE. The operations of 1405 may be performed in accordance with examples as disclosed herein. In some examples, aspects of the operations of 1405 may be performed by a situational information manager 825 as described with reference to FIG. 8.

At 1410, the method may include generating assistance information associated with a second UE different from the first UE, the assistance information being based on the situational information and including one or more parameters indicative of a condition of the second UE, the second UE being linked to the first UE. The operations of 1410 may be performed in accordance with examples as disclosed herein. In some examples, aspects of the operations of 1410 may be performed by an assistance information manager 830 as described with reference to FIG. 8.

At 1415, the method may include transmitting at least a portion of the assistance information to a second network entity different from the first network entity. The operations of 1415 may be performed in accordance with examples as disclosed herein. In some examples, aspects of the operations of 1415 may be performed by an assistance information manager 830 as described with reference to FIG. 8.

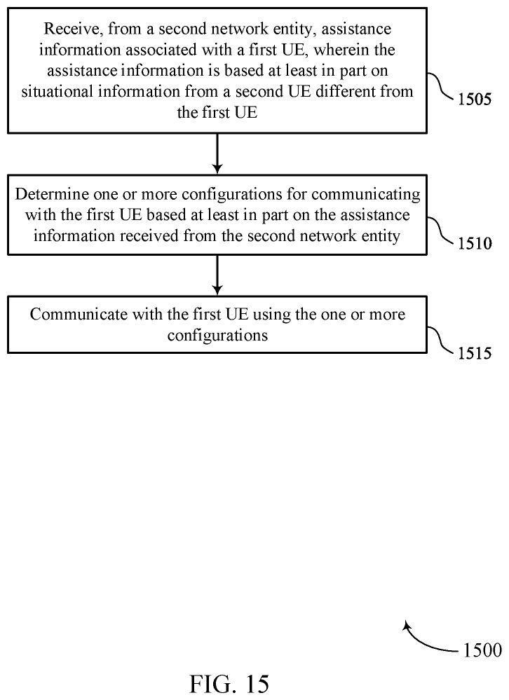

FIG. 15 shows a flowchart illustrating a method 1500 that supports sensing-aided RAT communications in accordance with one or more aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a second network entity, assistance information associated with a first UE, where the assistance information is based on situational information from a second UE different from the first UE. The operations of 1505 may be performed in accordance with examples as disclosed herein. In some examples, aspects of the operations of 1505 may be performed by an assistance information manager 830 as described with reference to FIG. 8.

At 1510, the method may include determining one or more configurations for communicating with the first UE based on the assistance information received from the second network entity. The operations of 1510 may be performed in accordance with examples as disclosed herein. In some examples, aspects of the operations of 1510 may be performed by a configuration manager 835 as described with reference to FIG. 8.

At 1515, the method may include communicating with the first UE using the one or more configurations. The operations of 1515 may be performed in accordance with examples as disclosed herein. In some examples, aspects of the operations of 1515 may be performed by a configuration manager 835 as described with reference to FIG. 8.

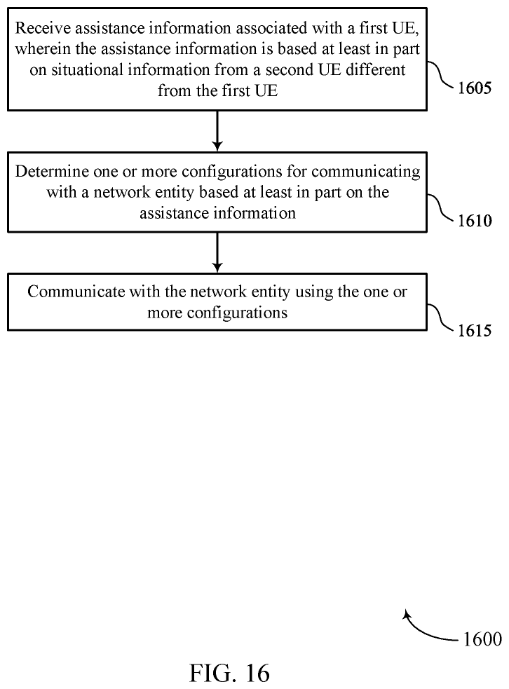

FIG. 16 shows a flowchart illustrating a method 1600 that supports sensing-aided RAT communications in accordance with one or more aspects of the present disclosure. The operations of the method 1600 may be implemented by a UE or its components as described herein. For example, the operations of the method 1600 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1605, the method may include receiving assistance information associated with the first UE, where the assistance information is based on situational information from a second UE different from the first UE. The operations of 1605 may be performed in accordance with examples as disclosed herein. In some examples, aspects of the operations of 1605 may be performed by an assistance information manager 1225 as described with reference to FIG. 12.

At 1610, the method may include determining one or more configurations for communicating with a network entity based on the assistance information. The operations of 1610 may be performed in accordance with examples as disclosed herein. In some examples, aspects of the operations of 1610 may be performed by a configuration manager 1230 as described with reference to FIG. 12.

At 1615, the method may include communicating with the network entity using the one or more configurations. The operations of 1615 may be performed in accordance with examples as disclosed herein. In some examples, aspects of the operations of 1615 may be performed by a configuration manager 1230 as described with reference to FIG. 12.

The following provides an overview of aspects of the present disclosure:

Aspect 1: A method for wireless communication at a first network entity, comprising: receiving situational information from a first UE; generating assistance information associated with a second UE different from the first UE, the assistance information being based at least in part on the situational information and comprising one or more parameters indicative of a condition of the second UE, the second UE being linked to the first UE; and transmitting at least a portion of the assistance information to a second network entity different from the first network entity.

Aspect 2: The method of aspect 1, further comprising: determining a first position of the second UE based at least in part on the situational information; and determining a second position of the second network entity, wherein transmitting the assistance information to the second network entity is based at least in part on a distance between the first position and the second position satisfying a distance threshold.

Aspect 3: The method of any of aspects 1 through 2, wherein generating the assistance information comprises: identifying one or more recommended or restricted beam directions for beam selection at the second network entity based at least in part on the situational information, and wherein transmitting at least the portion of the assistance information to the second network entity comprises: transmitting the one or more recommended or restricted beam directions for beam selection to the second network entity.

Aspect 4: The method of any of aspects 1 through 3, further comprising: transmitting at least another portion of the assistance information to the second UE to aid in communications between the second UE and the second network entity.

Aspect 5: The method of aspect 4, wherein the other portion of the assistance information comprises one or more recommended or restricted beam directions for beam selection at the second UE, a range of a beam sweep for the second UE to perform during beam selection, or a combination thereof.

Aspect 6: The method of any of aspects 4 through 5, wherein the other portion of the assistance information comprises handover information associated with a third network entity, measurements associated with the third network entity, an indication of interference from nearby network entities, measurement demands from nearby network entities, or a combination thereof.

Aspect 7: The method of any of aspects 1 through 6, further comprising: determining that the second network entity is associated with a serving cell for communicating with the second UE, wherein transmitting the assistance information to the second network entity is based at least in part on the determining.

Aspect 8: The method of any of aspects 1 through 7, further comprising: selecting one or more network entities including the second network entity for coordinated multipoint communications with the second UE; and coordinating communications between the second UE and the selected one or more network entities based at least in part on the assistance information.

Aspect 9: The method of any of aspects 1 through 8, further comprising: predicting a future position of the second UE based at least in part on the situational information, wherein transmitting the assistance information to the second network entity comprises: transmitting a message indicating the predicted future position to the second network entity.

Aspect 10: The method of any of aspects 1 through 9, wherein the situational information comprises a position of the second UE, a propagation loss associated with communications with the second UE, a velocity of the second UE, a movement direction of the second UE, a speed of the second UE, an acceleration of the second UE, a location or other motional information of one or more objects surrounding the second UE, or a combination thereof.

Aspect 11: The method of any of aspects 1 through 10, wherein the situational information is based at least in part on data collected at one or more sensors at the first UE, one or more sensors at one or more other UEs, or a combination thereof.

Aspect 12: The method of any of aspects 1 through 11, wherein the first network entity and the second network entity are associated with different radio access technologies or a same radio access technology.

Aspect 13: A method for wireless communication at a first network entity, comprising: receiving, from a second network entity, assistance information associated with a first UE, wherein the assistance information is based at least in part on situational information from a second UE different from the first UE; determining one or more configurations for communicating with the first UE based at least in part on the assistance information received from the second network entity; and communicating with the first UE using the one or more configurations.

Aspect 14: The method of aspect 13, wherein determining the one or more configurations for communicating with the first UE comprises: determining, based at least in part on the assistance information, a set of directional beams associated with a beam sweeping operation for selecting a beam for communicating with the first UE, the method further comprising: performing the beam sweeping operation using the set of directional beams, wherein the communicating with the first UE is based at least in part on the beam sweeping operation.

Aspect 15: The method of any of aspects 13 through 14, wherein determining the one or more configurations for communicating with the first UE comprises: determining, based at least in part on the assistance information, at least one of resources or a modulation and coding scheme for communicating with the first UE, wherein the communicating with the first UE is based at least in part on the resources, the modulation and coding scheme, or both.

Aspect 16: The method of any of aspects 13 through 15, wherein determining the one or more configurations for communicating with the first UE comprises: determining, based at least in part on the assistance information, one or more power allocation configurations, one or more interference mitigation configurations, or both, for communicating with the first UE, wherein the communicating with the first UE is based at least in part on the one or more power allocation configurations, the one or more interference mitigation configurations, or both.

Aspect 17: The method of any of aspects 13 through 16, further comprising: transmitting, based at least in part on the assistance information, control information configuring one or more of a set of directional beams associated with a beam sweeping operation, reference signal transmissions, or a threshold number of retransmissions for communicating with the first UE, wherein the communicating with the first UE is based at least in part on the control information.

Aspect 18: The method of any of aspects 13 through 17, wherein the situational information comprises a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

Aspect 19: A method for wireless communication at a first UE, comprising: receiving assistance information associated with the first UE, wherein the assistance information is based at least in part on situational information from a second UE different from the first UE; determining one or more configurations for communicating with a network entity based at least in part on the assistance information; and communicating with the network entity using the one or more configurations.

Aspect 20: The method of aspect 19, wherein determining the one or more configurations for communicating with the network entity comprises: determining, based at least in part on the assistance information, a set of directional beams associated with a beam sweeping operation for selecting a beam for communicating with the network entity, the method further comprising: performing the beam sweeping operation using the set of directional beams, wherein the communicating with the network entity is based at least in part on the beam sweeping operation.

Aspect 21: The method of any of aspects 19 through 20, wherein determining the one or more configurations for communicating with the network entity comprises: determining, based at least in part on the assistance information, at least one of resources or a modulation and coding scheme for communicating with the network entity, wherein the communicating with the network entity is based at least in part on the resources, the modulation and coding scheme, or both.

Aspect 22: The method of any of aspects 19 through 21, wherein determining the one or more configurations for communicating with the network entity comprises: determining, based at least in part on the assistance information, one or more power allocation configurations, one or more interference mitigation configurations, or both, for communicating with the network entity, wherein the communicating with the network entity is based at least in part on the one or more power allocation configurations, the one or more interference mitigation configurations, or both.

Aspect 23: The method of any of aspects 19 through 22, wherein the situational information comprises a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

Aspect 24: An apparatus for wireless communication at a first network entity, comprising a processor; memory coupled with the processor; and instructions stored in the memory and executable by the processor to cause the apparatus to perform a method of any of aspects 1 through 12.

Aspect 25: An apparatus for wireless communication at a first network entity, comprising at least one means for performing a method of any of aspects 1 through 12.

Aspect 26: A non-transitory computer-readable medium storing code for wireless communication at a first network entity, the code comprising instructions executable by a processor to perform a method of any of aspects 1 through 12.

Aspect 27: An apparatus for wireless communication at a first network entity, comprising a processor; memory coupled with the processor; and instructions stored in the memory and executable by the processor to cause the apparatus to perform a method of any of aspects 13 through 18.

Aspect 28: An apparatus for wireless communication at a first network entity, comprising at least one means for performing a method of any of aspects 13 through 18.

Aspect 29: A non-transitory computer-readable medium storing code for wireless communication at a first network entity, the code comprising instructions executable by a processor to perform a method of any of aspects 13 through 18.

Aspect 30: An apparatus for wireless communication at a first UE, comprising a processor; memory coupled with the processor; and instructions stored in the memory and executable by the processor to cause the apparatus to perform a method of any of aspects 19 through 23.

Aspect 31: An apparatus for wireless communication at a first UE, comprising at least one means for performing a method of any of aspects 19 through 23.

Aspect 32: A non-transitory computer-readable medium storing code for wireless communication at a first UE, the code comprising instructions executable by a processor to perform a method of any of aspects 19 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first network entity, comprising:
a processor;
memory coupled with the processor; and
instructions stored in the memory and executable by the processor to cause the apparatus to:
receive situational information from a first user equipment (UE);
generate assistance information associated with a second UE different from the first UE, the assistance information being based at least in part on the situational information and comprising one or more parameters indicative of a condition of the second UE, the second UE being linked to the first UE; and
transmit at least a portion of the assistance information to a second network entity different from the first network entity.

2. The apparatus of claim 1, wherein the instructions are further executable by the processor to cause the apparatus to:
determine a first position of the second UE based at least in part on the situational information; and
determine a second position of the second network entity, wherein transmitting the assistance information to the second network entity is based at least in part on a distance between the first position and the second position satisfying a distance threshold.

3. The apparatus of claim 1, wherein the instructions to generate the assistance information are executable by the processor to cause the apparatus to:
identify one or more recommended or restricted beam directions for beam selection at the second network entity based at least in part on the situational information, and wherein transmitting at least the portion of the assistance information to the second network entity comprises:
transmit the one or more recommended or restricted beam directions for beam selection to the second network entity.

4. The apparatus of claim 1, wherein the instructions are further executable by the processor to cause the apparatus to:
transmit at least another portion of the assistance information to the second UE to aid in communications between the second UE and the second network entity.

5. The apparatus of claim 4, wherein the other portion of the assistance information comprises one or more recommended or restricted beam directions for beam selection at the second UE, a range of a beam sweep for the second UE to perform during beam selection, or a combination thereof.

6. The apparatus of claim 4, wherein the other portion of the assistance information comprises handover information associated with a third network entity, measurements associated with the third network entity, an indication of interference from nearby network entities, measurement demands from nearby network entities, or a combination thereof.

7. The apparatus of claim 1, wherein the instructions are further executable by the processor to cause the apparatus to:
determine that the second network entity is associated with a serving cell for communicating with the second UE, wherein transmitting the assistance information to the second network entity is based at least in part on the determining.

8. The apparatus of claim 1, wherein the instructions are further executable by the processor to cause the apparatus to:
select one or more network entities including the second network entity for coordinated multipoint communications with the second UE; and
coordinate communications between the second UE and the selected one or more network entities based at least in part on the assistance information.

9. The apparatus of claim 1, wherein the instructions are further executable by the processor to cause the apparatus to:
predict a future position of the second UE based at least in part on the situational information, wherein transmitting the assistance information to the second network entity comprises:
transmit a message indicating the predicted future position to the second network entity.

10. The apparatus of claim 1, wherein the situational information comprises a position of the second UE, a propagation loss associated with communications with the second UE, a velocity of the second UE, a movement direction of the second UE, a speed of the second UE, an acceleration of the second UE, a location or other motional information of one or more objects surrounding the second UE, or a combination thereof.

11. The apparatus of claim 1, wherein the situational information is based at least in part on data collected at one or more sensors at the first UE, one or more sensors at one or more other UEs, or a combination thereof.

12. The apparatus of claim 1, wherein the first network entity and the second network entity are associated with different radio access technologies or a same radio access technology.

13. An apparatus for wireless communication at a first network entity, comprising:
a processor;
memory coupled with the processor; and
instructions stored in the memory and executable by the processor to cause the apparatus to:
receive, from a second network entity, assistance information associated with a first user equipment (UE), wherein the assistance information is based at least in part on situational information from a second UE different from the first UE;
determine one or more configurations for communicating with the first UE based at least in part on the assistance information received from the second network entity; and
communicate with the first UE using the one or more configurations.

14. The apparatus of claim 13, wherein the instructions to determine the one or more configurations for communicating with the first UE are executable by the processor to cause the apparatus to:
determine, based at least in part on the assistance information, a set of directional beams associated with a beam sweeping operation for selecting a beam for communicating with the first UE, wherein the instructions are further executable by the processor to cause the apparatus to:
perform the beam sweeping operation using the set of directional beams, wherein the communicating with the first UE is based at least in part on the beam sweeping operation.

15. The apparatus of claim 13, wherein the instructions to determine the one or more configurations for communicating with the first UE are executable by the processor to cause the apparatus to:
determine, based at least in part on the assistance information, at least one of resources or a modulation and coding scheme for communicating with the first UE, wherein the communicating with the first UE is based at least in part on the resources, the modulation and coding scheme, or both.

16. The apparatus of claim 13, wherein the instructions to determine the one or more configurations for communicating with the first UE are executable by the processor to cause the apparatus to:
determine, based at least in part on the assistance information, one or more power allocation configurations, one or more interference mitigation configurations, or both, for communicating with the first UE, wherein the communicating with the first UE is based at least in part on the one or more power allocation configurations, the one or more interference mitigation configurations, or both.

17. The apparatus of claim 13, wherein the instructions are further executable by the processor to cause the apparatus to:
transmit, based at least in part on the assistance information, control information configuring one or more of a set of directional beams associated with a beam sweeping operation, reference signal transmissions, or a threshold number of retransmissions for communicating with the first UE, wherein the communicating with the first UE is based at least in part on the control information.

18. The apparatus of claim 13, wherein the situational information comprises a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

19. An apparatus for wireless communication at a first user equipment (UE), comprising:
a processor;
memory coupled with the processor; and
instructions stored in the memory and executable by the processor to cause the apparatus to:
receive assistance information associated with the first UE, wherein the assistance information is based at least in part on situational information from a second UE different from the first UE;
determine one or more configurations for communicating with a network entity based at least in part on the assistance information; and
communicate with the network entity using the one or more configurations.

20. The apparatus of claim 19, wherein the instructions to determine the one or more configurations for communicating with the network entity are executable by the processor to cause the apparatus to:
determine, based at least in part on the assistance information, a set of directional beams associated with a beam sweeping operation for selecting a beam for communicating with the network entity, wherein the instructions are further executable by the processor to cause the apparatus to:
perform the beam sweeping operation using the set of directional beams, wherein the communicating with the network entity is based at least in part on the beam sweeping operation.

21. The apparatus of claim 19, wherein the instructions to determine the one or more configurations for communicating with the network entity are executable by the processor to cause the apparatus to:
determine, based at least in part on the assistance information, at least one of resources or a modulation and coding scheme for communicating with the network entity, wherein the communicating with the network entity is based at least in part on the resources, the modulation and coding scheme, or both.

22. The apparatus of claim 19, wherein the instructions to determine the one or more configurations for communicating with the network entity are executable by the processor to cause the apparatus to:
determine, based at least in part on the assistance information, one or more power allocation configurations, one or more interference mitigation configurations, or both, for communicating with the network entity, wherein the communicating with the network entity is based at least in part on the one or more power allocation configurations, the one or more interference mitigation configurations, or both.

23. The apparatus of claim 19, wherein the situational information comprises a location of the first UE, a propagation loss associated with communications with the first UE, a velocity of the first UE, a movement direction of the first UE, a speed of the first UE, an acceleration of the first UE, a location or other motional information of objects surrounding the first UE, or a combination thereof.

24. A method for wireless communication at a first network entity, comprising:
receiving situational information from a first user equipment (UE);
generating assistance information associated with a second UE different from the first UE, the assistance information being based at least in part on the situational information and comprising one or more parameters indicative of a condition of the second UE, the second UE being linked to the first UE; and
transmitting at least a portion of the assistance information to a second network entity different from the first network entity.

25. The method of claim 24, further comprising:
determining a first position of the second UE based at least in part on the situational information; and
determining a second position of the second network entity, wherein transmitting the assistance information to the second network entity is based at least in part on a distance between the first position and the second position satisfying a distance threshold.

26. The method of claim 24, wherein generating the assistance information comprises:
identifying one or more recommended or restricted beam directions for beam selection at the second network entity based at least in part on the situational information, and wherein transmitting at least the portion of the assistance information to the second network entity comprises:
transmitting the one or more recommended or restricted beam directions for beam selection to the second network entity.

27. The method of claim 24, further comprising:
transmitting at least another portion of the assistance information to the second UE to aid in communications between the second UE and the second network entity.

28. The method of claim 27, wherein the other portion of the assistance information comprises one or more recommended or restricted beam directions for beam selection at the second UE, a range of a beam sweep for the second UE to perform during beam selection, or a combination thereof.

29. The method of claim 27, wherein the other portion of the assistance information comprises handover information associated with a third network entity, measurements associated with the third network entity, an indication of interference from nearby network entities, measurement demands from nearby network entities, or a combination thereof.

30. The method of claim 24, further comprising:
determining that the second network entity is associated with a serving cell for communicating with the second UE, wherein transmitting the assistance information to the second network entity is based at least in part on the determining.
